(19) United States
(12) Patent Application Publication
(10) Pub. No.: US 2010/0070592 A1
(43) Pub. Date: Mar. 18, 2010

(54) RECEIVING EMAIL WITHIN AN EMAIL THREAD

(76) Inventors: Michael Samuel Steuer, Los Angeles, CA (US); David Ryan Waldman, Santa Monica, CA (US); Gustavo De Greiff, Santa Monica, CA (US)

Correspondence Address: Michael Samuel Steuer, 11406 Missouri Ave., Los Angeles, CA, 90025, US

(21) Appl. No.: 12/212,684

(22) Filed: Sep. 18, 2008

(51) Int. Cl. G06F 15/16

(52) U.S. Cl. 709/206

(57) ABSTRACT

Methods and apparatus for communication by electronic mail have been provided, for example, allowing or disallowing a blind copy (Bcc) recipient, of an original electronic mail, to receive reply electronic mail. An embodiment of the invention is a method of communicating by electronic mail. The method comprises forming a decision to allow or to disallow a first recipient to receive a first reply electronic mail, and forwarding the first reply electronic mail to the first recipient. An originator of an original electronic mail forms the decision. The invention enables, for example, enabling a Bcc recipient to receive reply electronic mails or reply email on a selective basis and doing so while not disclosing the identity or existence of the Bcc recipient to the other recipients.

### CROSS REFERENCE TO RELATED PATENT APPLICATIONS

The present application is related to the U.S. patent application identified as Attorney Docket No. 31908DSW-1 entitled “Method And Apparatus For Electronic Communication,” filed concurrently herewith, the disclosure of which is incorporated by reference herein.

The present application is related to the U.S. patent application identified as Attorney Docket No. 31908DSW-2 entitled “Address Replacement In Electronic Communication,” filed concurrently herewith, the disclosure of which is incorporated by reference herein.

### FIELD OF THE INVENTION

This invention relates generally to the formation and transmission of electronic mail. More specifically, this invention relates to specific email recipients, for example, a blind copy (Bcc) recipient receiving reply electronic mail within an electronic mail thread.

### BACKGROUND OF THE INVENTION

Electronic mail, for example email and text messaging is used extensively for personal and business communication. Often, email messages are sent to more than one recipient, for example one or more primary (To) recipients, one or more courtesy copy (Cc) recipients, and one or more blind copy (Bcc) recipients. Sometimes, it is desirable to exclude the Bcc recipients from receiving reply email within an email thread. At other times, it is desirable to include the Bcc recipient in receiving reply email within the email thread. It is usually intended to keep the identity and, at times, the existence of the Bcc recipient secret.

### SUMMARY OF THE INVENTION

Principles of the invention provide, for example, methods and apparatus for communication by electronic mail or email, where the originator of an original electronic communication or an original email has control over the Bcc recipient receiving or not receiving reply electronic mail or reply email within an electronic mail or email thread.

For example, in accordance with one aspect of the invention, a method of communicating by electronic mail is provided. The method comprises forming a decision to allow or to disallow a first recipient to receive a first reply electronic mail, and forwarding the first reply electronic mail to the first recipient. An originator of an original electronic mail forms the decision.

Advantages of the invention are, for example, enabling a Bcc recipient to receive reply electronic mails or reply email on a selective basis and doing so while not disclosing the identity or existence of the Bcc recipient to the other recipients.

These and other features, objects and advantages of the present invention will become apparent from the following detailed description of illustrative embodiments thereof, which is to be read in connection with the accompanying drawings.

### BRIEF DESCRIPTION OF THE DRAWINGS

FIG. 1 shows a method allowing a Bcc recipient to receive email within an email thread or disallowing the Bcc recipient from receiving the email within the email thread, according to an exemplary embodiment of the invention.

FIG. 4 illustrates an email composer window, according to an exemplary embodiment of the invention.

FIG. 10 illustrates a computer system in accordance with which one or more components/steps of the techniques of the invention may be implemented, according to an exemplary embodiment of the invention.

### DETAILED DESCRIPTION OF THE INVENTION

The term electronic mail, as used herein, refers to a communication, comprising text, by electronic means, for example, email and text messaging.

The term email server, as used herein, is a computer acting as a mail transfer agent (MTA), that is, the email server is running appropriate software, for example an MTA computer program. The email server, along with the appropriate software, transfers electronic mail messages from one computer to another. An MTA is also termed a mail transport agent, message transfer agent, simple mail transfer protocol (SMTP) daemon and extended or enhanced simple mail transfer protocol (ESMTP) daemon. The email server typically is coupled to a network, for example, the Web, Internet or an intranet, to facilitate email transfer.

The term client, as used herein, is a computing resource of an originator, a receiver, or a responder to an email. The client is, for example, the computing resource on which the electronic mail is composed, received, or responded to. The client is, for example, a computer, a laptop, a workstation, a text messaging device, personal digital assistant, a cellular phone, a portable Web access device, a television set top box, or a public email computing resource adapted to sending and receiving email. The client may be, for example, an on-site computing resource which is in the possession of an originator. Clients can be associated with other entities besides the originator. Unless specified otherwise, client refers to the client of the originator. The originator is, for example, an originator or recipient of an email or other electronic mail.

There is a need for a concise method of communication by electronic mail, for example, email, wherein, the originator of an original electronic communication or original email has control over the Bcc recipient receiving or not receiving reply electronic mail or reply email within an electronic or email thread.

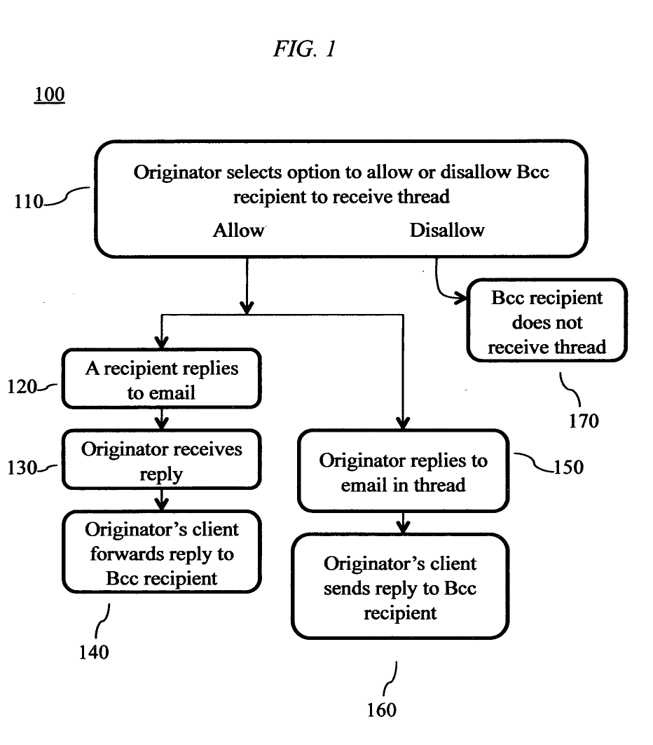

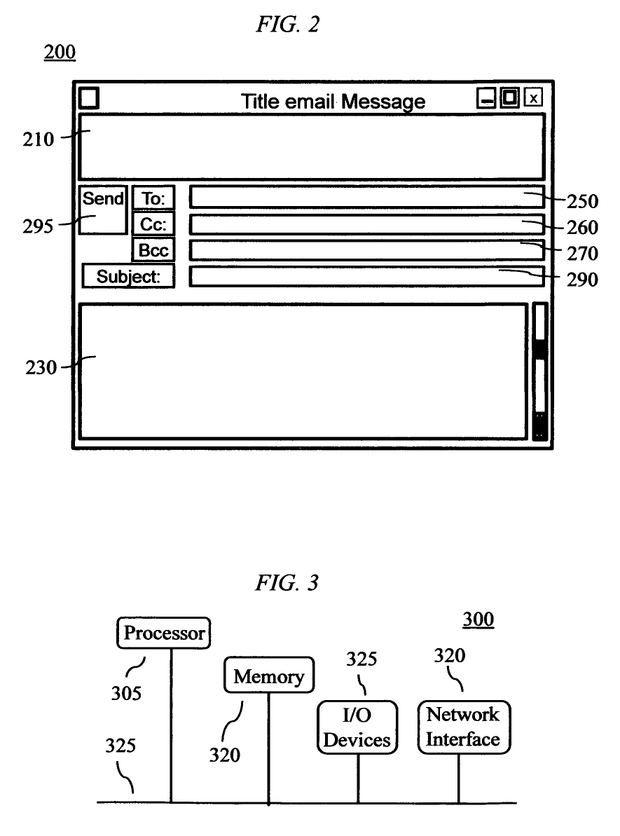

FIG. 1 shows a method 100 of communication by email according to an embodiment of the invention. FIG. 1 shows the steps of the method 100 occurring in an exemplary order. The invention is not so limited; the steps may occur in other orders.

The identity of the Bcc recipient is typically not disclosed to the To and Cc recipients or to other Bcc recipients. Consequently, the To and Cc recipients can not normally include the Bcc recipient as a recipient to a response email. Thus, the Bcc recipient will normally not receive an email within an email thread, past the original email. A method 100 allowing a Bcc recipient to receive email within an email thread or disallowing the Bcc recipient from receiving the email within the email thread is shown in FIG. 1. In the method 100, it is not necessary for the Bcc recipient to become known to the To and Cc recipients, even if he is allowed to receive emails, other than an original email, of an email thread. The email thread comprises the original email, any reply email to the original email, and any reply email to emails within the email thread.

In the first step 110, the originator selects to allow the Bcc recipient to receive emails within the email thread or to disallow the Bcc recipient form receiving emails within the email thread. The originator is the originator of the original email. If the originator allows the Bcc recipient to receive the emails of the email thread, one of two paths is followed. The first path is for the Bcc recipient to receive a reply email from a To or Cc recipient, as shown in steps 120, 130 and 140. The second path is for the Bcc recipient to receive a reply email from the originator, as shown in steps 150 and 160.

The first path includes the second step 120, a To or Cc recipient replies to an email. The email replied to can be the original email or any email in the email thread. The To or Cc recipient does not intentionally send the reply email to the Bcc recipient. The To or Cc recipient are typically not aware of the existence or identity off the Bcc recipient. The To or Cc recipient does, however, send the reply email to the originator. The next step in the first path is the third step 130; the originator receives the reply email. The originator receiving the reply email comprises a client of the originator receiving the reply email. In the last step of the first path, the fourth step 140, the client of the originator forwards the reply email to the Bcc recipient. Note that the reply email could also have come from another Bcc recipient instead of coming from the To or Cc recipient.

The second path includes the fifth step 150, the originator replies to an email in the email thread. In the last step of the second path, the sixth step 160, the client of the originator sends the reply of the originator to the Bcc recipient.

If the decision in the first step 110, is that the Bcc recipient is disallowed from receiving email within the email thread, then the seventh step 170 applies; the Bcc recipient does not receive any email within the email thread, except the original email. In this embodiment, the decision to allow or disallow the Bcc recipient to receive emails within the email thread is made once for any given email thread. The client of the originator may be instructed to automatically forward replies to the Bcc recipient. In a different embodiment, the decision to allow or disallow the Bcc recipient to receive emails within the email thread is made on an email by email basis. Thus, the originator decides for each response email if the Bcc recipient is to receive the particular response email or not. The client of the originator may be instructed to automatically forward replies to the Bcc recipient.

In some embodiments of the described invention, the method 100 is for communication by email, the term email being interpreted in the narrow sense indicating use of an email transfer protocol, for example, SMTP or ESMTP. In additional embodiments, email is understood as electronic mail encompassing additional communications protocols, for example text messaging. In one additional embodiment, text messaging is used. For example, text messaging that uses a short message service communications protocol or a multimedia messaging service protocol.

FIG. 2 illustrates an email composer window 200 according to an embodiment of the invention. The email composer window 200 comprises control and option block 210, message entry block 230, To recipient address entry block 250, Cc recipient address entry block 260, Bcc recipient address entry block 270, subject entry block 290, and send button 295. The control and option block 210 is a standard feature of most email composer windows. It typically comprises buttons to control the email or to select or set options of the email, for example, buttons associated with attachments, save to file, address book, email priority, insert signature, spell check, and fonts. The subject entry block 290 is where the subject of the email is, optionally, entered. The send button 295 is selected to send the email. Selecting the send button 295 is typically performed by clicking on the send button 295.

FIG. 3 illustrates a computer system in accordance with which one or more components/steps of the techniques of the invention may be implemented, for example, the components/steps depicted in FIGS. 1 and 2. It is to be further understood that the individual components may be implemented on one or more such computer system. In the case of an implementation on a distributed computing system, the individual computer systems and/or devices may be connected via a suitable network, e.g., cellular phone network, the Internet, the World Wide Web, a private network, or a local network. The invention is not limited to any particular network.

The computer system shown in FIG. 3 may represent one or more servers, mobile or stationary computing devices, one or more other processing devices, or one or more memory devices capable of providing all or portions of the functions described herein. The computer system may generally include a processor 305, memory 310, input/output (I/O) devices 315, and network interface 320, coupled via a computer bus 325.

It is to be appreciated that the term “processor” as used herein is intended to include any processing device, such as, for example, one that includes a central processing unit (CPU) and/or other processing circuitry. It is also to be understood that the term “processor” may refer to more than one processing device and that various elements associated with a processing device may be shared by other processing devices. Processors may include memory, for example, cache memory.

The term “memory” as used herein includes memory embedded within a processor, an I/O device, and a network interface, for example, a cache memory within a processor. Memory may be embedded within an integrated circuit having other functions, for example, a processor chip with embedded memory. Alternately, memory may be within an integrated circuit functioning mainly as a memory integrated circuit. The term “memory” as used herein is intended to also include memory associated with a processor or CPU, such as, for example, random access memory (RAM), read only memory (ROM), a fixed memory device (e.g., hard disk drive), a removable memory device (e.g., diskette, compact disk, digital video disk or flash memory module), flash memory, non-volatile memory, etc. The memory may be considered a computer readable storage medium. At least one memory contains one or more software programs according to embodiments the invention, for example, one or more software programs formed to implement the method 100 allowing a Bcc recipient to receive the email thread or disallowing the Bcc recipient from receiving the email thread.

In addition, the phrase “input/output devices” or “I/O devices” as used herein is intended to include, for example, one or more input devices (e.g., keyboard, mouse, camera, etc.) for entering data to the processing unit, and/or one or more output devices (e.g., display, etc.) for presenting results associated with the processing unit.

Still further, the phrase “network interface” as used herein is intended to include, for example, one or more transceivers to permit the computer system to communicate with another computer system via an appropriate communications protocol.

Although illustrative embodiments of the invention have been described herein with reference to the accompanying drawings, it is to be understood that the invention is not limited to those precise embodiments, and that various other changes and modifications may be made therein by one skilled in the art without departing from the scope of the appended claims.

Embodiments of the invention illustrate the invention adapted for use with email. The invention is not so limited. Embodiments of the invention are adapted for use with electronic mail, for example, test messaging.

What is claimed is:

1. A method of communication by electronic mail, wherein the method comprises the steps of:
forming a decision to allow or to disallow a first recipient to receive a first reply electronic mail, wherein an originator of an original electronic mail forms the decision; and
forwarding the first reply electronic mail to the first recipient.

2. The method of claim 1 further comprising the step of:
forming the first reply electronic mail in reply to an electronic mail within an electronic mail thread.

3. The method of claim 2 further comprising the steps of:
sending the first reply electronic mail to the originator; and
receiving, by the originator, the first reply electronic mail, wherein a second recipient of the original electronic mail forms the first reply electronic mail.

4. The method of claim 2, wherein the electronic mail thread comprises the original electronic mail, a second reply electronic mail in reply to the original electronic mail, and a third reply electronic mail in reply to at least one of the second reply electronic mail, and any other electronic mail within the electronic mail thread.

5. The method of claim 1, wherein the first recipient is a blind copy recipient.

6. The method of claim 5, wherein an identity of the first recipient is not disclosed to a second recipient of the original electronic mail.

7. The method of claim 2, wherein the originator forms the first reply electronic mail.

8. The method of claim 2, wherein the forming of the decision occurred prior to the forming the first reply electronic mail.

9. The method of claim 8, wherein a client of the originator is adapted to one of automatically forward and automatically not forward the first reply email.

10. The method of claim 2, wherein the forming of the decision occurred after the forming the first reply electronic mail.

11. The method of claim 9, wherein the client of the originator is at least one of a laptop, a workstation, a computer, a text messaging device, a cellular phone, a personal digital assistant, a portable web access device, a television set top box, and a public e-mail computing resource adapted to sending and receiving an electronic mail message.

12. The method of claim 1, wherein the first reply electronic mail comprises a first reply email, wherein the original electronic mail comprises an original email, and wherein the first reply email and the original email are sent using at least one of a simple mail transfer protocol, extended simple mail transfer protocol, and enhanced simple mail transfer protocol.

13. The method of claim 1, wherein the first reply electronic mail comprises a first reply text message, wherein the original electronic mail comprises an original text message, and wherein the first reply text message and the original test message are sent using at least one of a short message service communications protocol and a multimedia messaging service protocol.

14. An article of manufacture for forming a communication by electronic mail, the article comprising a computer readable storage medium having one or more programs embodied therewith, wherein the one or more programs, when executed by a computer, perform steps of:
forming a decision to allow or to disallow a first recipient to receive a first reply electronic mail, wherein an originator of an original electronic mail forms the decision; and
forwarding the first reply electronic mail to the first recipient.

15. The article of manufacture of claim 14, wherein the one or more programs, when executed by the computer, further perform step of:
forming the first reply electronic mail in reply to an electronic mail within an electronic mail thread.

16. The article of manufacture of claim 14, wherein the one or more programs, when executed by the computer, further perform steps of:
sending the first reply electronic mail to the originator; and
receiving, by the originator, the first reply electronic mail, wherein a second recipient of the original electronic mail forms the first reply electronic mail.

17. Apparatus for forming a communication by electronic mail, the apparatus comprising:
a memory;
a processor coupled to the memory and configured to:
form a decision to allow or to disallow a first recipient to receive a first reply electronic mail, wherein an originator of an original electronic mail forms the decision; and
forward the first reply electronic mail to the first recipient

18. The apparatus of claim 17, wherein the processor coupled to the memory is further configured to:
form the first reply electronic mail in reply to an electronic mail within an electronic mail thread.

19. The apparatus of claim 17, wherein the processor coupled to the memory is further configured to:
send the first reply electronic mail to the originator; and
receive the first reply electronic mail, wherein a second recipient of the original electronic mail forms the first reply electronic mail.
